(19) United States
(12) Patent Application Publication
(10) Pub. No.: US 2025/0200492 A1
(43) Pub. Date: Jun. 19, 2025

(54) Determination of an Impact IMPA of Deployment of an Autonomous Vehicle in an Environment

(71) Applicant: Siemens Aktiengesellschaft, München (DE)

(72) Inventors: Iris Fuhrmann, Bad Driburg (DE); Andrew Gill, Zeilarn (DE); Andrea Kollmorgen, München (DE); Igor Passchier, The Hague (NL); Edward Slavin III, Robbinsville, NJ (US)

(73) Assignee: Siemens Aktiengesellschaft, München (DE)

(21) Appl. No.: 18/852,037

(22) PCT Filed: Mar. 30, 2022
(86) PCT No.: PCT/EP2022/058459

§ 371 Date: Sep. 27, 2024

(51) Int. Cl. G06Q 10/067; G06Q 10/0639; G06Q 50/40

(52) U.S. Cl. CPC G06Q 10/067; G06Q 10/06393; G06Q 50/40

(57) ABSTRACT

Various embodiments of the teachings herein include a method for estimating an impact resulting from deploying an autonomous vehicle (AV) characterized by an AV stack in an environment. An example includes: performing simulation runs; in each run, generating a simulated time dependent AV behavior and a simulated time dependent traffic behavior utilizing simulation conditions and data from the AV stack; forming output data comprising the simulated AV behavior, the simulated traffic behavior, and at least a part of the input data; and analyzing the output data for some or all of the simulation runs using an analytic engine module to estimate the impact based on the analysis result.

### CROSS-REFERENCE TO RELATED APPLICATIONS

This application is a U.S. National Stage Application of International Application No. PCT/EP2022/058459 filed Mar. 30, 2022, which designates the United States of America, the contents of which are hereby incorporated by reference in their entirety.

### TECHNICAL FIELD

The present disclosure relates to autonomous vehicles. Various embodiments include methods and/or systems for determining an impact of deploying an autonomous vehicle, or a fleet of autonomous vehicles.

### BACKGROUND

Although true level 4 and level 5 autonomy for vehicles is still on the horizon, recent years have seen the accelerated deployment of autonomous vehicles, in the following occasionally “AV”, in limited deployment environments, for tasks like people and goods movement and with applied constraints such as “only in day light” or “not in rain” or “only up to speeds of 20 km/h” etc. In typical AV setups, a so called “AV stack” comprises the software required to perform perception of the environment of the AV and respective processing of collected data, route and path planning, and vehicle actuation. Perception might include semantic understanding of the world by interpretation of various sensor modalities, typically cameras, LiDAR, and Radar. Route and path planning might include planning a global route from a location A to a location B and then determining the incremental steps to get there. Vehicle actuation might include steering, accelerating, braking, etc. of the AV.

It is often the case that to perform an AV deployment in an environment, the stakeholder responsible for the deployment environment must rely on safety and performance data provided by the companies responsible for creating the AV stack software, with little ability for them to attempt to verify these claims, and specifically, to verify these claims in the actual environment in which the AV will now be deployed. This lack of independent expertise to analyze the safety of the AV in its deployment environment or to understand the impact of the AV, e.g. which impact on congestion or journey time would the AV have, is a challenge for not only the responsible deployment environment stakeholder, but also for the entire AV ecosystem to guarantee smooth and uninterrupted traffic and, in more general terms, undisturbed environment.

For example, fleet operators have an inability to compare multiple AV stack providers in different deployment environments, which reduces accuracy and liability of general risk assessment as well as safety considerations performed by such operators and which also impacts corresponding traffic management systems. Moreover, insurance companies today have no historical risk profiles nor data of their own to help them determine the potential liability risk of the AV deployment.

Today, all such players in the AV ecosystem must, in many cases, blindly trust the data provided by the AV stack provider, who has a vested interest in allowing the vehicles equipped with their AV stack to be deployed or make decisions and judgements that are not based on relevant insights. Aside from the inherent conflict of interest, currently there is no realistic procedure to independently analyze and assess the provided safety data and performance data and to analyze and assess the provided data specifically in the context of where the vehicles will be deployed to be able to understand the local and network impact of the deployed one or more autonomous vehicles.

Often the AV stack algorithms are designed and developed based on generic environments with generic traffic profiles, where exactly defined traffic situations are considered. However, location matters, as an AV deployed in a densely populated city center will behave differently to the same AV deployed in the countryside. The deployment environments are different, e.g. from weather to road surface quality, from number of pedestrians to the behavior of human drivers in rush hour. Also, the deployment environment will not be covered fully by situations considered in the development stage. How an AV really behaves in its deployment environment and what effect the AV has on the other actors in that environment, e.g. human driven vehicles, cyclists, pedestrians etc., are necessary critical insights for the AV ecosystem stakeholders. Furthermore, due to the vast amounts of data required to make a statement on safety and performance metrics, there is no good way to translate this into something operational for a particular stakeholder in the ecosystem to make a decision with regard to deployment in a specific location.

Until now, the deployment of AVs relies on the ecosystem trusting the AV stack provider that safety data they are providing is accurate. In many cases, this may involve on-site evaluation of the provider's software development process as well as long periods of live testing before a deployment can go live.

While the AV stack provider has likely tested the software under a wide range of conditions, formally described by the “Operational Design Domain” (ODD), this often does not guarantee that the safety and performance data acquired during these tests are the same safety and performance data that would result from the AV operating in a specific deployment location and environment, respectively. As such, a true local context is ignored when making the deployment assessment in all but the most trivial cases that can be covered by many miles of live testing.

When testing, AV stack developers might rely on simulation to augment live miles, driven in real-world, because they cannot exhaustively test the vehicle in the live domain in a timely fashion. In real-world testing a lot of miles are driven where nothing happens, leading to a high probability that safety-critical situations may be missed due to their low probability of occurrence. In many cases the AV development simulations do not address the local context in which they will be deployed, because they do not know this a priori: They are related to a set of defined operating conditions, the ODD, not to the deployment location. Specifically, they often do not account for the specifics of the scenery where the deployment takes place, including all of its imperfections, the historical behavior of a typical (manual) driver in the deployment location, traffic densities and patterns unique to the specific area and to specific times of day, movement and behavior of adjacent traffic actors such as cyclists and pedestrians where those behaviors often have a local characterization, both for compliant and non-compliant behavior, specific topology and weather patterns unique to the area, events that dramatically change these typical behaviors and create new ones unique to the environment, e.g. sporting events, inoperable traffic lights, etc., other autonomous actors operating in the same space, the impact that an AV may have on the network in which is deployed, and the potential changing risk profiles of the deployment location when an AV is operating within mixed AV-non-AV traffic.

Oftentimes, the deployment environment stakeholders lack the technical expertise to properly evaluate the AV software stack and must rely on extensive, but still limited, live testing in the environment to make any sort of assessment. This can result in over- or underestimating a risk and impact of deploying an AV in an environment as there is a lack of historical data necessary to assess the risk profile of a particular autonomous vehicle, with a particular AV stack, in a particular deployment location, and under a varying range of environmental conditions.

For example, in case of insurance companies, the burden of proof is often shifted to the companies, which in turn have limited technical expertise of how the AV stack works and performs, and typically rely on a large ballpark dollar figure to appropriately cover the potential liability that ensues from the deployment. This of course can result in either severely under- or over-insuring the AV deployment.

### SUMMARY

Teachings of the present disclosure may be useful for determining a risk profile of a particular autonomous vehicle, with a particular AV stack, in a particular deployment location, and under a varying range of environmental conditions. For example, some embodiments include a computer-implemented method for estimating an impact IMPA resulting from deploying an autonomous vehicle AV, which is characterized by an AV stack AV_ST, in an environment, wherein one or more simulation runs SIM(i) are performed, e.g. by a simulation module MOD_SIM, with i=1, . . . ,I and I representing the total number of performed simulation runs SIM(i), in each simulation run SIM(i), e.g. in a co-simulation setup, a simulated time dependent AV behavior AV_BEHA(i) of the vehicle AV in the environment and a simulated time dependent traffic behavior TRA_BEHA(i) of traffic in the environment are generated, utilizing simulation conditions IN_ADD(i) and data AV_CTRL from the AV stack AV_ST, output data OUT_SIM(i) are formed comprising the simulated AV behavior AV_BEHA(i), the simulated traffic behavior TRA_BEHA(i), and at least a part of the input data IN_ADD(i), and the output data OUT_SIM(i) is analyzed for some or all of the simulation runs SIM(i), e.g. by an analytic engine module MOD_ANEN, to estimate the impact IMPA based on the analysis result.

In some embodiments, an AV simulator AV_SIM simulates the AV behavior AV_BEHA(i) and a traffic simulator TR_SIM simulates the traffic behavior TRA_BEHA(i), wherein the AV behavior AV_BEHA(i) comprises time development of states STAT_AV(i) of the vehicle AV, and the traffic behavior TRA_BEHA(i) comprises time development of states STAT_SIG of variable traffic signs SIG in the environment and time development of states STAT_ACT of moving or movable traffic actors ACT in the environment.

In some embodiments, in each simulation run SIM(i) the simulation of the AV behavior AV_BEHA(i) and of the traffic behavior TRA_BEHA(i) is based on a mutual interaction of the AV simulator AV_SIM and the traffic simulator TR_SIM, wherein the AV simulator AV_SIM processes an output OUT_TR of the traffic simulator TR_SIM and the traffic simulator TR_SIM processes an output OUT_AV of the AV simulator AV_SIM, a mutual interaction of the AV simulator AV_SIM with the AV stack AV_ST, wherein the AV stack AV_ST processes an AV worldview WOVI_AV provided by the AV simulator AV_SIM and the AV simulator AV_SIM processes a vehicle control signal AV_CTRL generated by the AV stack AV_ST, and processing of the input data IN_ADD(i) in the AV simulator AV_SIM and in the traffic simulator TR_SIM.

In some embodiments, the simulation of the traffic behavior TRA_BEHA(i) is based on the input data IN_ADD(i) and on an output OUT_AV(i) of the AV simulator AV_SIM, and the simulation of the AV behavior AV_BEHA (i) is based on the input data IN_ADD (i), on an output OUT_TR(i) of the traffic simulator TR_SIM, and on a vehicle AV control signal AV_CTRL provided by the AV stack AV_ST.

In some embodiments, the AV stack AV_ST is configured to process a worldview WOVI_AV(i) of the vehicle AV simulated in and received from the AV simulator AV_SIM to generate the data AV_CTRL and to provide the data AV_CTRL to the AV simulator AV_SIM.

In some embodiments, the impact IMPA is composed of values KPI_VAL of pre-defined key performance indicators KPI and/or pre-defined severity indicators SEV_EV, wherein the output data OUT_SIM(i) is analyzed for each simulation run SIM(i) to determine the values KPI_VAL and/or the severity indicators SEV_EV.

In some embodiments, the impact IMPA is composed of safety related information RISK and traffic performance TRIM, wherein the determined KPI values KPI_VAL are assigned to the safety related information RISK or to the traffic performance TRIM depending on a KPI type for which the respective KPI value KPI_VAL has been determined, and/or the determined severity indicators SEV_EV are assigned to the safety related information RISK or to the traffic performance TRIM depending on an event type EV(i,j) for which the respective severity indicator SEV_EV has been determined.

In some embodiments, the values KPI_VAL of the key performance indicators KPI and/or the severity indicators SEV_EV, respectively, are determined based on pre-defined event types EV(i,j) occurring in individual simulation runs SIM(i), with j=1, . . . ,J(i) and J(i) representing the number of different event types EV identified for a particular simulation run SIM(i), wherein for each simulation run SIM(i) the event types EV(i,j) occurred in the respective simulation run SIM(i) are identified by analyzing the respective output OUT_SIM(i).

In some embodiments, for the determination of the values KPI_VAL of the key performance indicators KPI, the for each identified event type EV(i,j) one or more key performance indicators KPI(i,j,k) characterizing the respective event type EV(i,j) as well as values KPI_VAL(i,j,k) of the determined characterizing key performance indicators KPI(i,j,k) are determined by analyzing the respective output OUT_SIM (i), with k=1, . . . , K (j) and K(j) representing the number of key performance indicators KPI characterizing a particular event type EV(i,j).

In some embodiments, for each identified event type EV(i,j) the severity indicators SEV_EV(i,j) are determined by processing the KPI values KPI_VAL(i,j,k) determined for the respective event type EV(i,j).

In some embodiments, for each one of one or more of the KPI(i′,j,k) of a subset SIM(i′) of the simulation runs SIM(i) the respective KPI values KPI_VAL(i′,j,k) are aggregated to form for each such key performance indicator KPI(i′,j,k) an aggregated KPI value KPI_VAL_{subi′}, (j, k), wherein such an aggregated KPI value KPI_VAL_{subi′}, (j, k) represents one of the KPI values KPI_VAL for composing the impact IMPA.

In some embodiments, for each one of one or more of the severity indicators SEV_EV(i′,j) of a subset SIM(i′) of the simulation runs SIM(i) the respective severity indicators SEV_EV(i′,j) are aggregated to form an aggregated severity indicator SEV_EV_{subi′}, (j), wherein such aggregated severity indicator SEV_EV_{subi′}, (j) represents one of the severity indicators SEV_EV for composing the impact IMPA.

In some embodiments, the simulation runs SIM(I′) forming the subset of simulation runs are selected from the entirety of simulation runs SIM(i) such that the selected simulation runs SIM(I′) have in common a value of at least one selection parameter of interest.

In some embodiments, the selection parameter of interest is a parameter of the input IN_ADD used as input for the simulation runs or is a location in the environment.

As another example, some embodiments include a system SIMPL for estimating an impact IMPA resulting from deploying an autonomous vehicle AV in an environment, comprising a simulation module MOD_SIM and an analytic engine module MOD_ANEN, wherein the system SIMPL is configured to execute one or more of the methods described herein.

### BRIEF DESCRIPTION OF THE DRAWINGS

In the following, possible embodiments of the different aspects of the present disclosure are described in more detail with reference to the enclosed figures. The objects as well as further advantages of the example embodiments will become more apparent and readily appreciated from the following description, taken in conjunction with the accompanying figure in which:

FIG. 1 shows a structure of a simulation platform incorporating teachings of the present disclosure;

FIG. 2 shows a flow chart of an example simulation method incorporating teachings of the present disclosure performed by a simulation module of the platform of FIG. 1; and

FIG. 3 shows a flow chart of an example analysis method incorporating teachings of the present disclosure performed by a analysis engine module of the platform of FIG. 1.

### DETAILED DESCRIPTION

Various embodiments of the teachings herein include methods for estimating an impact IMPA, e.g. comprising traffic impact TRIM and/or risk insights RISK, resulting from deploying an autonomous vehicle AV in an environment, wherein the vehicle AV is characterized by an AV stack AV_ST, might use a simulation module MOD_SIM and an analytic engine module MOD_ANEN or a similar, more integrated architecture. The impact IMPA describes an impact of the AV deployment on safety related information RISK and traffic performance TRIM in the environment. The simulation module MOD_SIM creates a simulated world of the deployment environment in which operation of the AV to be evaluated and of other traffic is simulated and performs, for that purpose, one or more simulation runs SIM(i) with i=1, . . . ,I and I representing the total number of performed simulation runs SIM(i).

In each simulation run SIM(i), e.g. in a co-simulation setup, a time span dT is considered and for that time span dT a simulated preferably time dependent AV behavior AV_BEHA(i) of the vehicle AV in the environment and a simulated time dependent traffic behavior TRA_BEHA(i) of traffic, especially including further actors ACT and variable signals SIG, in the environment are generated, utilizing simulation conditions IN_ADD(i) and data AV_CTRL from the AV stack AV_ST, wherein such data AV_CTRL might be vehicle control signals. Output data OUT_SIM(i) are formed comprising the simulated AV behavior AV_BEHA(i), the simulated traffic behavior TRA_BEHA(i), and at least a part of the utilized simulation conditions IN_ADD(i). Finally, the output data OUT_SIM(i) are analyzed for some or all of the simulation runs SIM(i), e.g. by the analytic engine module MOD_ANEN, to estimate the impact IMPA based on the analysis result.

The insights IMPA resulting from executing the proposed method have direct effect on either changing the environment itself, e.g. by introducing or changing the traffic regulation, e.g. by tools like fixed and variable signs, and/or to adapt the AV stack AV_ST so that risks and general traffic impact caused by deploying the AV in the environment are reduced. The functions introduced above can be distributed to the simulation module MOD_SIM and the analytic engine module MOD_ANEN. However, it is also possible t>hat an integrated platform realizes the functionality.

The simulation conditions IN_ADD(i) might include static environment parameters DAT_OE(i) representing static features of the environment and/or dynamic scenario descriptions DAT_SD(i) representing time dependent and/or dynamic features of the environment and of the simulation. Therein, a “time dependent” state STAT of an object means that such state STAT includes a series of values of such states over time, e.g. describing the change of position, speed, and acceleration etc. of the AV over time or the change of the signal of a traffic light over time, each within a time span covered by the respective simulation run.

Here and in the following, the word family of “simulating” a variable or a parameter based on some input data includes that the input data are processed to simulate the variable or parameter and to generate the corresponding simulated variable or parameter as an output.

The simulation module MOD_SIM might comprise an AV simulator AV_SIM to simulate and generate the AV behavior AV_BEHA(i) and a traffic simulator TR_SIM to simulate traffic in the simulated world that surrounds the AV after its deployment and to simulate and generate the traffic behavior TRA_BEHA(i). The AV behavior AV_BEHA(i) comprises time development of states STAT_AV(i) of the vehicle AV while the traffic behavior TRA_BEHA(i) comprises time development of states STAT_SIG(i) of variable traffic signs SIG in the environment and time development of states STAT_ACT(i) of moving or movable traffic actors ACT in the environment.

In each simulation run SIM(i), the simulation of the AV behavior AV_BEHA(i) and of the traffic behavior TRA_BEHA(i) might be based on a mutual interaction of the AV simulator AV_SIM and the traffic simulator TR_SIM, wherein the AV simulator AV_SIM processes an output OUT_TR of the traffic simulator TR_SIM and the traffic simulator TR_SIM processes an output OUT_AV of the AV simulator AV_SIM, a mutual interaction of the AV simulator AV_SIM with the AV stack AV_ST, wherein the AV stack AV_ST processes an AV worldview WOVI_AV provided by the AV simulator AV_SIM and the AV simulator AV_SIM processes a vehicle control signal AV_CTRL generated by the AV stack AV_ST, and processing of the simulation conditions IN_ADD(i) in the AV simulator AV_SIM and in the traffic simulator TR_SIM. Thus, the AV simulator and the traffic simulator may work in a co-simulation setup.

Therein, a mutual interaction between two entities means an exchange of data generated by one of the entities and required by the other entity, wherein such data exchange is bidirectional.

The simulation of the traffic behavior TRA_BEHA(i) in the traffic simulator TR_SIM might be based on the simulation conditions IN_ADD(i) and on an output OUT_AV(i) of the AV simulator AV_SIM, especially including the states STAT_AV(i) and their time dependence, e.g. the time dependent AV behavior AV_BEHA(i), of the vehicle AV. The simulation of the AV behavior AV_BEHA(i) in the AV simulator AV_SIM might be based on the simulation conditions IN_ADD(i), on an output OUT_TR(i) of the traffic simulator TR_SIM, especially including the states STAT_SIG(i) of the variable traffic signs SIG and the states STAT_ACT (i) of other moving or movable traffic actors ACT in the environment, e.g. the time dependent traffic behavior TRA_BEHA(i), and on a vehicle AV control signal AV_CTRL provided by the AV stack AV_ST.

The AV stack AV_ST can be configured to process a worldview WOVI_AV(i) of the vehicle AV simulated in and received from the AV simulator AV_SIM to generate a vehicle control signal AV_CTRL and to provide the vehicle control signal AV_CTRL to the AV simulator AV_SIM.

The impact IMPA might be composed of values KPI_VAL of pre-defined key performance indicators KPI and/or pre-defined severity indicators SEV_EV, wherein the analytic engine module MOD_ANEN might analyze the output data OUT_SIM(i) of the simulation module MOD_SIM for each simulation run SIM(i), i.e. for each i, to determine the values KPI_VAL and/or the severity indicators SEV_EV to compose the impact IMPA.

On another level, the impact IMPA might be composed of safety related information RISK and traffic performance TRIM, both of which result from the deployment of the vehicle AV in the environment, wherein each one of the determined KPI values KPI_VAL is assigned to the safety related information RISK or alternatively to the traffic performance TRIM depending on a KPI type for which the respective KPI value KPI_VAL has been determined and/or each one of the determined severity indicators SEV_EV is assigned to the safety related information RISK or alternatively to the traffic performance TRIM depending on an event type EV(i,j) for which the respective severity indicator SEV_EV has been determined.

The values KPI_VAL of the pre-defined key performance indicators KPI and/or the pre-defined severity indicators SEV_EV, respectively, might be determined based on event types EV(i,j) occurring in individual simulation runs SIM(i), with j=1, . . . ,J(i) and J(i) representing the number of different event types EV identified for a particular simulation run SIM(i), i.e. individually for different event types occurring in the simulation runs. The analytic engine module MOD_ANEN might identify, for each simulation run SIM(i), the event types EV(i,j) occurred in the respective simulation run SIM(i) by analyzing the respective output OUT_SIM(i).

For the determination of the values KPI_VAL of the pre-defined key performance indicators KPI, the analytic engine module MOD_ANEN might determine, for each identified event type EV(i,j), one or more key performance indicators KPI(i,j,k) characterizing the respective event type EV(i,j) as well as values KPI_VAL(i,j,k) of the determined characterizing key performance indicators KPI(i,j,k) by analyzing the respective output OUT_SIM(i), with k=1, . . . ,K(j) and K(j) representing the number of key performance indicators KPI characterizing a particular event type EV(i,j).

Furthermore, the analytic engine module MOD_ANEN might determine, for each identified event type EV(i,j), the severity indicators SEV_EV(i,j) by processing the KPI values KPI_VAL(i,j,k) determined for the respective event type EV(i,j).

Summarizing the activities of the analytic engine module MOD_ANEN up to here, for each simulation run SIM(i) a set of event types EV(i,j) occured in a respective simulation run SIM(i) is provided as well as KPI types KPI(i,j,k) which are characterizing for the occured event types EV(i,j) and the respective values KPI_VAL(i,j,k). Moreover, severity indicators SEV_EV(i,j) for the event types EV(i,j) are provided.

The analytic engine module MOD_ANEN might aggregate for each one of one or more of the KPI(i′,j,k) of a subset SIM(i′) of the simulation runs SIM(i) individually the respective KPI values KPI_VAL(i′,j,k) to form for each such key performance indicator KPI (i′, j, k) an aggregated KPI value KPI_VAL_{subi′}, (j, k). Such an aggregated KPI value KPI_VAL_{subi′}, (j, k) represents one of the KPI values KPI_VAL for composing the impact IMPA. In other words, for each such KPI type individually, those respective KPI values are aggregated, e.g. summed up or averaged, possibly using weighing factors, which have been determined earlier for those simulation runs SIM(i′) which are part of the subset SIM(i′) of simulation runs. Thus, for each respective subset SIM(i′) of simulation runs, one aggregated KPI value results for each KPI type KPI(j,k) of each event type EV(j).

Furthermore, the analytic engine module MOD_ANEN might aggregate, for each one of one or more of the severity indicators SEV_EV(i′, j) of a subset SIM(i′) of the simulation runs SIM(i) individually the respective severity indicators SEV_EV(i′,j) to form an aggregated severity indicator SEV_EV_{subi′}(j). Such aggregated severity indicator SEV_EV_{subi′}(j) represents one of the severity indicators SEV_EV for composing the impact IMPA. In other words, for each such severity indicator individually, those respective values are aggregated, e.g. summed up or averaged, possibly using weighing factors, which have been determined earlier for those simulation runs SIM(i′) which are part of the subset SIM(i′) of simulation runs. Thus, for each respective subset SIM(i′) of simulation runs, one aggregated severity indicator results for each event type EV(j).

The simulation runs SIM(I′) forming the subset of simulation runs might be selected from the entirety of simulation runs SIM(i) such that the selected simulation runs SIM(I′) have in common a value of at least one selection parameter of interest. In other words, for a given subset, the value of the selection parameter of interest is the same for all simulation runs of that subset.

The selection parameter of interest might be, for example, a parameter of the simulation conditions IN_ADD used as input for the simulation runs or a location in the environment. For example, the parameter of interest taken from IN_ADD can be the “weather” assumed for a respective simulation run. The value of the parameter “weather” might be, for example, “sunny” or “rainy” etc. Thus, in this scenario all simulation runs assuming “rainy” weather would form a subset. Simulation runs with “sunny” weather would form another subset. In another example, the parameter of interest can be the “location” of an event EV. The value can be a certain coordinate in the simulated world, e.g. the location of a certain intersection. In that scenario, it can be assumed that the subset of simulation runs will comprise all simulation runs because that “common” location is actually available in all simulation runs. Thus, the subset can be identical to the entirety of simulation runs. This might also be applicable with other selection parameters.

A respective system or platform SIMPL for estimating an impact IMPA, e.g. comprising traffic impact TRIM and/or risk insights RISK, resulting from deploying an autonomous vehicle AV in an environment, wherein the AV is characterized by an AV stack AV_ST, comprises a simulation module MOD_SIM and an analytic engine module MOD_ANEN, wherein the system SIMPL is configured to execute a method as described above.

The elements and features recited in the appended claims may be combined in different ways to produce new claims that likewise fall within the scope of the present disclosure. Thus, whereas the dependent claims appended below depend on only a single independent or dependent claim, it is to be understood that these dependent claims can, alternatively, be made to depend in the alternative from any preceding or following claim, whether independent or dependent, and that such new combinations are to be understood as forming a part of the present specification.

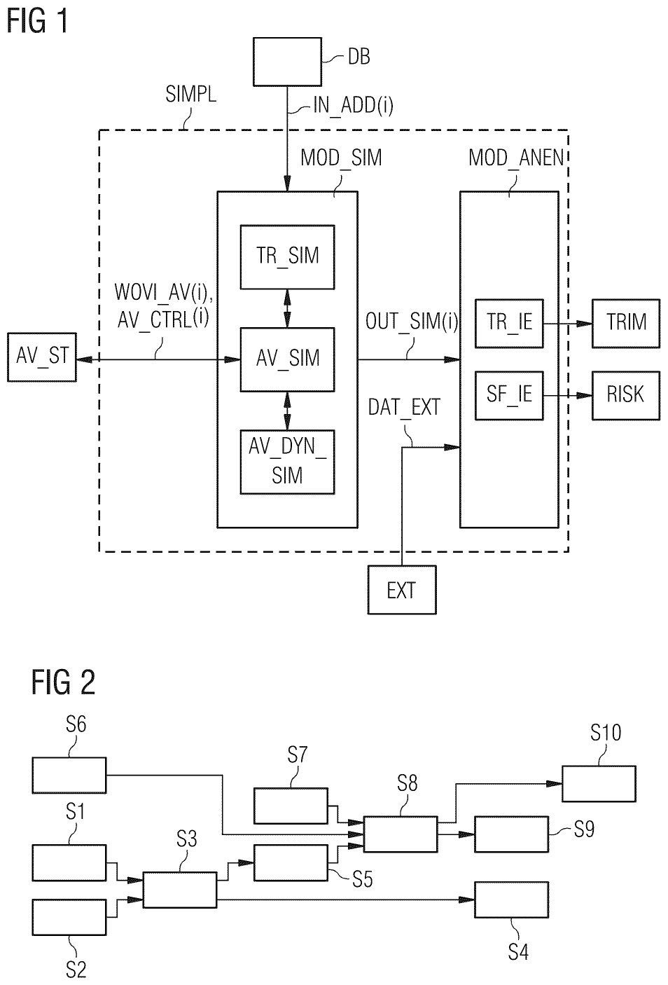

FIG. 1 shows an example simulation platform SIMPL incorporating teachings of the present disclosure for simulating the behavior of one or more particular AVs in a specific deployment environment and for analyzing the corresponding results to derive an impact IMPA from deploying the one or more AVs in that environment. In some embodiments, the platform SIMPL is realized as a cloud-based platform. The platform SIMPL comprises a software implemented simulation module MOD_SIM and a software implemented analytic engine module MOD_ANEN. The platform SIMPL can be implemented on a corresponding processor of a computer, wherein different modules of the platform as described below might be implemented on a common processor or on separate processors.

The simulation module MOD_SIM allows to simulate the behavior of one or more particular AVs in the specific deployment environment with sufficient level of detail to allow an output OUT_SIM of the simulation module MOD_SIM to be used by the analytic engine module MOD_ANEN for the determination of the impact and insights of AV deployment on safety and traffic of the deployment environment, expressed and represented by outputs “risk insights” RISK and “traffic impact” TRIM and summarized under the term impact IMPA of the analytic engine module MOD_ANEN and, therewith, of the simulation platform SIMPL. For that, the simulation module MOD_SIM processes certain input to create a simulated world of the deployment environment in which operation of the AV to be evaluated and of other traffic is simulated.

In the following, it is assumed that the impact of only one autonomous vehicle AV to be deployed in the environment shall be evaluated. The simulation module MOD_SIM can be coupled to one or more specific AV stacks AV_ST, e.g. implemented by “Apollo” open-source software, corresponding to the one or more AVs to be deployed and evaluated for data exchange. However, as already mentioned, the following assumes only one autonomous vehicle. Correspondingly, only one AV stack AV_ST is shown in FIG. 1.

Further input IN_ADD to the simulation module MOD_SIM like parameters DAT_OE of the operational deployment environment and a scenario description DAT_SD can be provided to the simulation platform SIMPL and to the simulation module MOD_SIM, respectively, from a database DB or other suitable source.

The parameters included in DAT_OE of the operational deployment environment might include, for example, detailed road layouts, road furnitures (equipment installations along streets and roads for various purposes), fixed traffic signs, buildings, trees, etc. and it might be used both in TR_SIM and AV_SIM. In short, DAT_OE represents static or fixed features of the environment. In some embodiments, DAT_OE might be used in an optional dedicated autonomous vehicle dynamics simulator AV_DYN_SIM of the simulation module MOD_SIM (to be introduced below). The parameters DAT_OE are used to describe the virtual deployment environment in which the AV and all other generated traffic in the traffic simulator TR_SIM will operate. Typically, the operational deployment environment and its parameters DAT_OE, respectively, is static and describes the static or non-time dependent part of the generated, simulated world where the AV and the other traffic will operate.

The scenario description DAT_SD might include parameters like weather information, e.g. with values “sunny”, “rainy”, or “snow fall”, driving behavior of other actors in the environment, traffic patterns, a route of the AV from a location A to a location B, etc. DAT_SD might be used both in TR_SIM and AV_SIM to generate the dynamic, i.e. time dependent, part of the environment where the AV and the other traffic will operate. In short, the scenario descriptions DAT_SD represent time dependent and/or dynamic features of the environment and of the simulation. Thus, the input IN_ADD can be considered to comprise simulation conditions of the simulation performed by the simulation module MOD_SIM.

The simulation module MOD_SIM comprises at least an autonomous vehicle simulator AV_SIM, e.g. “Simcenter Prescan”, and a large-scale micro and meso traffic simulator TR_SIM, e.g. “Aimsun Next”. Those possible realizations of the modules TR_SIM, AV_SIM via “Simcenter Prescan” and “Aimsun Next” allow to perform all the functions and calculations, respectively, of the simulation module MOD_SIM described below. However, those concrete embodiments are only exemplary and must not be understood to be limiting the scope of the present disclosure.

The traffic simulator TR_SIM can be configured to simulate traffic in the simulated world that surrounds the AV after its deployment. Therein, the simulation includes information about the location of certain events. The traffic simulation includes the traffic simulator TR_SIM simulating the behavior of variable traffic signs SIG in the simulated world which can change their state over time, e.g. traffic lights or gates at railway crossings etc., and controlling the behavior of all moving or movable traffic actors ACT in the simulated world, e.g. other vehicles, pedestrians, trams, busses, trucks, trains, etc. Therein, the term “behavior” actually means the development of the states of the respective objects ACT, SIG over time. For the simulations, it takes an output OUT_AV of the autonomous vehicle simulator AV_SIM, i.e. the AV state STAT_AV and its behavior over time as introduced below, and uses that as one of the inputs to create the behavior TRA_BEHA of the traffic surrounding the deployed AV. Herein, “traffic” includes both the actors ACT and the variable signs SIG.

Here and in the following, a “state” essentially refers to moment in time wherein, as indicated above, a “behavior” includes the time dependence of such state, i.e. the development and potential change of the state over time.

Correspondingly, an output OUT_TR of the traffic simulator TR_SIM, essentially describing the traffic behavior TRA_BEHA, includes the time dependences of the states STAT_ACT of all moving or movable traffic actors ACT in the simulated world and of the states STAT_SIG of the variable traffic signs SIG in the simulated world. Such state STAT_ACT of a traffic actor typically includes at least a position, velocity, and/or acceleration of such actor ACT, each time may be in three dimensions (3D). The states STAT_SIG include the states of the variable traffic signs, e.g. “red”, “yellow”, green” of a traffic light or “open”, “close” of a gate etc. The behavior TRA_BEHA of the traffic ACT, SIG actually also represents the change of the states STAT_ACT, STAT_SIG over time since a simulation run SIM(i) does not only consider a singular point in time but a comprehensive time span dT.

Thus, the output of the traffic simulator TR_SIM for further processing in the analytic engine module MOD_ANEN is OUT_TR={TRA_BEHA}. In some embodiments, corresponding states might also be included, i.e. OUT_TR={TRA_BEHA, STAT_ACT, STAT_SIG}.

The AV simulator AV_SIM can be configured to simulate a worldview WOVI_AV of the autonomous vehicle AV based on the input IN_ADD including DAT_OE, DAT_SD and based on the output OUT_TR of the traffic simulator TR_SIM which is essentially comprising the states STAT_ACT of traffic actors and the states STAT_SIG of variable traffic signs SIG, e.g. “red”, “yellow”, or “green” in case of a traffic light or corresponding meanings for concerned simulated traffic and “gate open” or “gated closed” for a railway crossing etc., in the simulated world, preferably over a time span dT. The worldview WOVI_AV represents the AV's perception of its nearby, perceivable surroundings, e.g. buildings, trees, fixed and variable signs, other objects in traffic, etc. which would typically be detected by a corresponding sensor system of the AV. Moreover, the AV simulator AV_SIM takes vehicle control signals AV_CTRL from the stack AV_ST to simulate the vehicle state STAT_AV as well as the AV behavior AV_BEHA and provides such information to the traffic simulator TR_SIM for further processing as indicated above. Therein, the vehicle control signal AV_CTRL includes at least the respective actuation signals for steering, accelerating, and braking. The vehicle state STAT_AV includes the vehicle AV position and orientation as well as first and higher order time derivatives of such position and orientation, e.g. speed and acceleration, while the AV behavior AV_BEHA describes the time dependence of the state STAT_AV. At least, the vehicle state STAT_AV includes position, speed, and acceleration of the vehicle AV. Moreover, states of the lighting system of the AV and other components, e.g. with effect on the surroundings of the AV, might be included in STAT_AV.

In some embodiments, the AV simulator AV_SIM can be configured to simulate dynamics AV_DYN of the autonomous vehicle AV and to utilize such dynamics AV_DYN in the simulation of the AV state STAT_AV. In some embodiments, the simulation module MOD_SIM might comprise a separate, dedicated autonomous vehicle dynamics simulator AV_DYN_SIM, e.g. “Simcenter Amesim”, which would be included in the simulation module MOD_SIM based on co-simulation technology. In that case, the autonomous vehicle dynamics simulator AV_DYN_SIM instead of the AV simulator AV_SIM takes over the function of simulating the dynamics of the AV. In other words, the simulation of the vehicle dynamics AV_DYN might be performed in the AV simulator AV_SIM or, in an alternative embodiment, the simulation module MOD_SIM comprises the separate autonomous vehicle dynamics simulator AV_DYN_SIM for simulating the vehicle dynamics AV_DYN.

In any case, vehicle dynamics AV_DYN includes change of the vehicle state STAT_AV over time, i.e. the time dependence of the vehicle state STAT_AV. Thus, such AV dynamics AV_DYN might have a certain overlap with AV_BEHA in that it also describes dynamics of the vehicle AV. In practice, one difference might be that AV_DYN will do that with smaller timesteps. Another major difference is that AV_DYN will not treat the vehicle AV as a single rigid body. In other words, in AV_DYN parts of the AV can move relative to each other. This is, for example, relevant for sensors, e.g. a camera shaking when driving over a bumpy road.

The vehicle dynamics AV_DYN is simulated in high fidelity by processing details from the input IN_ADD, e.g. road layout, static traffic signs, objects like buildings and trees, weather, time of day, and any environmental conditions etc. especially of the static world, the state STAT_AV, and the control signals AV_CTRL from the AV stack AV_ST. Thus, the output of the AV simulator AV_SIM for further processing in the analytic engine module MOD_ANEN is OUT_AV={AV_BEHA}. In some embodiments, corresponding states might also be included, i.e. OUT_TR={AV_BEHA, STAT_AV}, wherein STAT_AV might include AV_DYN.

In some embodiments, the AV simulator AV_SIM can be configured to hand off the dynamic behavior AV_DYN of the AV to AV_DYN_SIM.

The AV stack AV_ST is configured to receive and process the simulated worldview WOVI_AV from the AV simulator AV_SIM to make continuously decisions on the vehicle control based on such worldview WOVI_AV to generate the vehicle control signal AV_CTRL. Such generated vehicle control signal AV_CTRL is subsequently provided back to the AV simulator AV_SIM.

Processing results of the simulators AV_SIM, TR_SIM, and optionally AV_DYN_SIM of the simulation module MOD_SIM are forming the output OUT_SIM of the simulation module MOD_SIM to the analytic engine module MOD_ANEN. At least, the output OUT_SIM comprises the AV behavior AV_BEHA and the traffic behavior TRA_BEHA as described above as well as the input IN_ADD to the simulation module MOD_SIM used to generate the simulated world and to simulate the AV in the deployment environment.

Thus, OUT_SIM={AV_BEHA, TRA_BEHA, IN_ADD}. Optionally, some or all of the corresponding states might also be included, i.e. OUT_SIM={AV_BEHA, TRA_BEHA, IN_ADD, STAT_AV, STAT_TRA, STAT_SIG}.

In other words, the output OUT_SIM includes an AV driving behavior AV_BEHA, which is actually the time dependence of the vehicle state STAT_AV, and, potentially, other traffic behavior TRA_BEHA in the deployment environment after the particular AV would have been deployed there, which is actually the time dependence of the states STAT_ACT, STAT_SIG of the traffic actors and signs and of the traffic, respectively. Thus, the output OUT_SIM of the simulation module MOD_SIM is focused on how the autonomous vehicle AV will behave in its deployment environment, including second order impacts on how the non-AV actors in the environment will behave. In general terms, the output OUT_SIM includes time dependent information about the state of the AV, about the states of the actors in the simulated world, and about the states of variable traffic signs as well as the input IN_ADD.

Typically, the states STAT_ACT of the actors, the state STAT_AV of the vehicle AV, the dynamics AV_DYN of the vehicle AV, the worldview WOVI_AV, and the states STAT_SIG of the traffic signs SIG are time dependent and, therefore, include in each case the development of the respective concerned parameters over a given time span dT, for example expressed by the respective behaviors. For example, elements position, speed, and acceleration of the vehicle AV, which are elements of the state STAT_AV, change over time with the vehicle AV moving around in the deployment area. The considered time span dT might be, for example, in the order of an hour.

The simulation module MOD_SIM realizes a co-simulation environment which brings together the autonomous vehicle simulator AV_SIM, the traffic simulator TR_SIM, and the specific AV stack AV_ST. For that, the coupling of the AV stack AV_ST with the autonomous vehicle simulator AV_SIM can be based on software-in-the-loop technology, while the autonomous vehicle simulator AV_SIM and the traffic simulator TR_SIM can be coupled based on co-simulation technology.

In general, in a co-simulation each one of the different subsystems that make up the complete system that is simulated by its own simulator. These individual simulators are then coupled to create a simulator for the complete system.

Two subsystems are distinguished: One subsystem represents the autonomous vehicle AV, simulated in the AV simulator AV_SIM. All other traffic and the traffic signs, especially variable traffic signs, of the simulated world in combination are considered to be the second subsystem, simulated in the traffic simulator TR_SIM. The coupling of the subsystems consists of the continuous exchange of information between the simulators AV_SIM and TR_SIM, where the relevant information from the AV is transferred from AV_SIM to TR_SIM, and the relevant information of the other traffic and the traffic signs is transferred from TR_SIM to AV_SIM.

In case the optional dedicated autonomous vehicle dynamics simulator AV_DYN_SIM is used, the vehicle dynamics AV_DYN of the AV is considered to be a further independent subsystem, being simulated in co-simulation with AV_SIM in a similar way. However, in the following it is assumed that the AV simulator AV_SIM includes the functions of the autonomous vehicle dynamics simulator AV_DYN_SIM and determines the vehicle dynamics AV_DYN.

The integration of the traffic simulator TR_SIM, the autonomous vehicle simulator AV_SIM, the AV stack AV_ST, and, as the case may be, the autonomous vehicle dynamics simulator AV_DYN_SIM in the simulation module MOD_SIM results in the ability to answer questions of different scales and provide analysis outputs and insights into the safety, performance, and impact of autonomous vehicles in a deployment location.

Based on the exemplary interplay and simulation method comprising steps S1-S9 performed by the simulation module MOD_SIM as exemplarily shown in FIG. 2, the simulators AV_SIM, TR_SIM, and, as the case may be, AV_DYN_SIM included in and used by the simulation module MOD_SIM allow to simulate at different levels of fidelity. For example, given time and computational power, a true physics-based simulation of sensors of the AV to be evaluated can be executed as part of the AV simulator AV_SIM to gain detailed insights on the dependency of the safety and traffic impact of the AV stack perception layer. Alternatively, a parameterized model or artificial intelligence (AI) model of such sensors can be used to speed up the simulation within the simulation module MOD_SIM with an accuracy loss acceptable under many different conditions.

In this regard, FIG. 2 shows example relationships in the AV-traffic co-simulation layer of the simulation module MOD_SIM and the interplay of the AV simulator AV_SIM and the traffic simulator TR_SIM in a particular simulation run SIM(i).

In a first step S1, sensor performance in specific detailed scenarios based on physics-based sensors of the AV is simulated, e.g. executed in the AV simulator AV_SIM. Information about which kind of sensor should be simulated as well as conditions and parameters for such simulation can be provided with the input IN_ADD.

In a second step S2, sensor performance is measured in specific, detailed test measurements of the AV. These measurements are measurements on the sensors that would be actually used on the AV during deployment, with the aim to generate data that can be used to determine the performance of the respective sensors in real situations.

Results from the first step S1 and the second step S2 are processed in a third step S3 to parameterize the sensors. The corresponding generic model of the sensor with tunable parameters is implemented as a part of the AV simulator AV_SIM. The values of these parameters are determined in step S3 in an optimization process such that the model output is as good as possible in agreement with the input from step S1 and/or step S2. Thus, from step S1 and/or step S2 data are available which describe the output of the sensor for a given input, and step S3 provides the parameter values such that the output of the model for the given input matches best with the sensor output for that same input.

The result of step 3 can be used in a fourth step S4 by the autonomous vehicle simulator AV_SIM and the traffic simulator TR_SIM to simulate the AV based on the parameterized sensors and software-in-the-loop control logic in complete city scenarios which are provided by the traffic simulator TR_SIM.

Additionally, the result of step 3 can be used in a fifth step S5 by the autonomous vehicle simulator AV_SIM and the traffic simulator TR_SIM to simulate the AV based on the parameterized sensors and software-in-the-loop control logic in specific traffic scenarios which are provided by the traffic simulator TR_SIM.

In a sixth step S6, performed in the AV simulator AV_SIM, control logic performance of the AV stack AV_ST, e.g. without the sensor, in specific scenarios is simulated.

In a seventh step S7, the time dependent vehicle state analogue to STAT_AV is measured during a test drive of the AV and in a field test, respectively.

The results of step S5 as well as results of the sixth step S6 and the seventh step S7 are processed in an eighth step S8 in order to to parameterize the control logic, preferably into a driver model. The processing for parameterization in the eighth step S8 essentially corresponds to the approach in the third step S3: A generic model of the control logic with tunable parameters is implemented as a part of the AV simulator AV_SIM. The values of these parameters are determined in step S8 in an optimization process such that the model output is as good as possible in agreement with the input from steps S5, S6, and S7. Thus, from step S5, S6, and S7 data are available which describe the output of the control logic for a given input, and step S8 provides the parameter values such that the output of the control logic model for the given input matches best.

The result of the parameterization of the eighth step S8 can be used in a ninth step S9, performed by the traffic simulator TR_SIM, to simulate the AV based on an AV driver model in a complete city scenario and/or to simulate in a tenth step S10 a large-scale deployment of AVs, i.e. the deployment of a plurality of AVs, in such complete city scenario.

The “complete city scenario” expresses that the scenario not only simulates a few streets or similar but a whole city.

Especially, step 5 can be performed with the co-simulation environment introduced above. However, the same is applicable for steps S1, S4, S6, S9, and S10.

The input IN_ADD to the simulation module MOD_SIM including DAT_OE and DAT_SD contains parameters that describe a stochastic model, such as the traffic models used in TR_SIM, or a distribution of possible values, such as potential weather conditions or the origin and destination of the AV, that are part of DAT_OE. The module MOD_SIM is actually used to execute one or more simulation runs SIM(i) with i=1,2, . . . ,I counting the individual simulation runs and I representing the total number of such simulation runs SIM(i), where for each simulation run SIM(i) all these parameters that describe a stochastic process or a range of values are fixed to a single value. Preferably, a random seed value can be selected as a starting point for each simulation run SIM(i) which ensures that all stochastic models in TR_SIM, AV_SIM, and optionally AV_DYN_SIM are fully deterministic.

In each simulation run SIM(i) the following parameters are determined and provided, respectively, to generate an output OUT_SIM(i) corresponding to the simulation run SIM(i): IN_ADD(i)={DAT_OE(i), DAT_SD(i)}, STAT_AV(i), potentially including AV_DYN(i), WOVI_AV(i), AV_CTRL(i), AV_BEHA(i), STAT_ACT(i), STAT_SIG(i), TRA_BEHA(i). However, not all such parameters used during a simulation run SIM(i) are provided to the analytic engine module MOD_ANEN, but the output OUT_SIM(i) from a single simulation run SIM(i) executed by the simulation module MOD_SIM includes at least the behaviors TRA_BEHA(i), AV_BEHA(i) and the input IN_ADD(i) for the particular simulation run SIM(i), i.e. OUT_SIM(i)={AV_BEHA(i), TRA_BEHA(i), IN_ADD(i)}. In some embodiments, some or all of the corresponding states might also be included, i.e. OUT_SIM(i)={AV_BEHA(i), TRA_BEHA(i), IN_ADD(i), STAT_AV(i), STAT_TRA(i), STAT_SIG(i)}.

Different simulation runs SIM(i), SIM(j) with i≠j might be different from each other in one or more parameters, e.g. the weather, e.g. “sunny” or “rainy”, to be assumed for the respective simulation, being an element of the scenario descriptions DAT_SD(i) of the input IN_ADD(i), or the traffic behavior TRA_BEHA(i). Thus, the conditions for the simulations in different simulation runs SIM(i), SIM(j) are typically different, resulting in different results OUT_TR(i), OUT_AV(i) etc. and OUT_SIM(i).

Summarizing and concretizing the above explanations, the simulation module MOD_SIM connects and combines, respectively, a set of three components comprising the AV-stack AV_ST, the autonomous vehicle simulator AV_SIM, and the traffic simulator TR_SIM to generate the output OUT_SIM(i). Thus, the following abilities are combined in MOD_SIM:
Creation of scenery and environment by the traffic simulator TR_SIM and the AV simulator AV_SIM, including (but not limited to) geographic maps, local topology, weather and lightning conditions, and traffic signaling to generate simulation-based input for sensor and control software stacks of AVs for a specific deployment location.
Generation of adjacent traffic actors to the AV, including (but not limited to) manually driven vehicles, cyclists, pedestrians, and mass transit using models specific to the deployment location. The adjacent traffic actors can be co-simulated by the traffic simulator TR_SIM in closed loop with the AV simulation. Therein, “closed loop” expresses that a first subsystem, e.g. the traffic simulator TR_SIM, reacts on a second subsystem, e.g. the AV simulator AV_SIM, and vice versa, where the subsystems refer to the subsystems of the co-simulation architecture.
Integration of the AV stack AV_ST of the AV to be deployed into the co-simulation solution of TR_SIM and AV_SIM to provide a system to determine the impact of the deployment of AVs on the environment and on objects in the environment.
Execution of a set of simulation runs based on the above three abilities for a given set of input parameters and a random seed, to take input account the variations over time of these input parameters in the actual deployment location, and to sample the stochastic models.

The analytic engine module MOD_ANEN, comprising a traffic impact engine TR_IE and a safety impact engine SF_IE, receives the output OUT_SIM(i) of the simulation module MOD_SIM for a respective simulation run SIM(i) as an input IN_ANEN(i)={OUT_SIM(i)} for further processing. In some embodiments, external data DAT_EXT are provided, e.g. IN_ANEN(i)={OUT_SIM(i), DAT_EXT}. Therein, the safety and traffic impact and insights to be finally provided by the analytic engine module MOD_ANEN can be based on the simulated behavior AV_BEHA of the one or more AVs in a specific deployment environment and/or on data DAT_EXT not originating from simulations but from real world.

The safety impact engine SF_IE is configured to derive AV safety related information RISK from the input IN_ANEM. AV safety related information is any information that describes the occurrence and/or consequences of accidents where the deployed AV is involved in or any information that has a relation with the occurrence and/or consequences of accidents where the deployed AV is involved in.

The traffic impact engine TR_IE is configured to derive any information TRIM from the input IN_ANEM in relation to traffic performance in the deployment area that is influenced by the deployment of the AV. For the sake of clarity, such traffic performance information TRIM does not include information in the field of AV safety since the latter is included in the safety related information RISK. The traffic performance is described in terms of traffic performance measures, such as travel time, e.g. average travel time, intersection throughput, queue lengths at controlled intersections, energy use, CO2 and greenhouse gas emissions, etc.

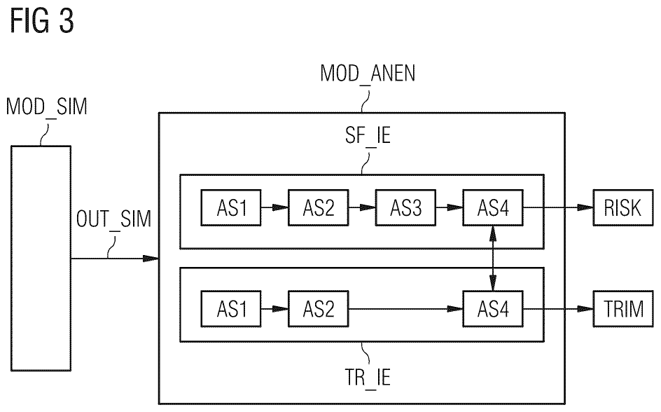

In other words, a variety of safety and traffic related aspects RISK, TRIM will be calculated by the analytic engine module MOD_ANEN, especially by using the simulated data OUT_SIM(i) provided by the simulation module MOD_SIM and real world data DAT_EXT from measurements performed on actually deployed AVs or other input sources from the deployment area, like cameras, radars, loop detectors, or other sensors installed in the deployment area, or information obtained from other road users in the deployment area. The entirety of those real-world sources of information are symbolized in FIG. 3 by “EXT” and the entirety of data provided by EXT is denoted “DAT_EXT”.

For example, the safety and traffic related aspects RISK, TRIM include and clarify, respectively, what the detailed performance of the sensor system of the AV would be, what the detailed performance of the sensor system together with the control system of the AV would be, what the performance of the AV in a specific traffic situation would be, what the performance of the AV in the intended deployment location would be, what the safety impact of a single AV when driving at a specific place and time, under specific conditions in the deployment environment would be, what the safety impact of multiple AVs from the same vendor when driving at a specific place and time, under specific conditions in the deployment environment would be, what the safety impact of multiple AVs from multiple vendors when driving at a specific place and time, under specific conditions in the deployment environment would be, what the safety impact on the non-AV actors within the deployment environment would be, how the non-AV actors react to the AV, what the traffic impact of a single AV when driving at a specific place and time, under specific conditions in the deployment environment would be, what the traffic impact of multiple AVs when driving at a specific place and time, under specific conditions in the deployment environment would be, what the risk factors associated with the deployment of the AV in the deployment environment would be (including outputs such as frequency of collisions, frequency of second order impacts on the non-AV actors, and risk profiling areas within the deployment location), what the overall safety and traffic impact on a city for different AV deployment scenarios would be, and/or how one AV stack performs against another in a specific deployment scenario.

The calculation of the traffic performance information TRIM and of the AV safety related information RISK, executed in the analytic engine module MOD_ANEN and based on the output OUT_SIM(i) of the simulation module MOD_SIM and, optionally, on the external data DAT_EXT, is essentially a process of four steps AS1-AS4:

In a first step AS1 of that processing, the results OUT_SIM(i) of the individual simulation runs SIM(i) introduced above are analyzed for each simulation run SIM(i) individually, resulting in the detection of event types EV(i,j), especially derived from the AV driving behavior AV_BEHA and other traffic behavior TRA_BEHA as determined and provided by MOD_SIM, with j=1, . . . ,J(i) and J(i) representing the number of different event types EV found for a particular simulation run SIM(i) in the analysis in the first step AS1. Examples of event types are “collision with other vehicle”, “collision with pedestrian”, “vehicle following”, “second order impact”, “near miss”, etc. Also, a very general event type can be “accident”.

The analysis in the first step AS1 might be based on identification of known data patterns in the respective data of OUT_SIM(i). For example, an event type “collision” can be characterized by a conspicuously fast change of the velocity of the AV. If applicable, a “collision” might also be detected by acceleration sensors. As another example, an event type “near miss” can be characterized by an unusually small distance between the AV and an actor or object of the simulated world. In some embodiments, a pre-defined list of imaginable event types with corresponding data patterns is provided in advance.

Thus, the first step AS1 provides the detected event types EV(i,j) for each simulation run SIM(i). The first step AS1 may be performed by both SF_IE and TR_IE.

In a second step AS2, values KPI_VAL(i,j,k) of key performance indicators KPI(i,j,k) are extracted for all detected event types EV(i,j) of each simulation run SIM(i). An event type EV(j) might be characterized by only one or, as the case may be, even more key performance indicators KPI (j, k) with k=1, . . . , K (j) and K(j) representing the number of characterizing key performance indicators KPI(j,k) of a particular event type EV(j). For example, an event type EV(J′)=“collision” might be characterized by a first key performance indicator KPI(J′,1)=“energy transferred to collision object”, a second key performance indicator KPI(J′,2)=“angle of impact”, a third key performance indicator KPI(J′,3)=“impact velocity” etc. For example, a pre-defined list of event types EV(j) and assigned key performance indicators KPI(j,k) is provided in advance. In case of the very general event type “accident”, a simple KPI type assigned to that event type might be “total number of accidents”.

Thus, the second step AS2 provides KPI values KPI_VAL(i,j,k) for key performance indicators KPI(i,j,k) characterizing for and assigned to the detected event types EV(i,j) of each simulation run SIM(i). The second step AS2 may be performed by both SF_IE and TR_IE. Just for example, the value KPI_VAL (i, J′, 1) of the first key performance indicator KPI(i,J′,1)=“energy transferred to collision object” introduced above can be easily calculated from the change of velocity of the AV in simulation run SIM(i) and further information like the mass of the AV etc. The value KPI_VAL(i,J′,3) of the other exemplary key performance indicator KPI (i, J′,3)=“impact velocity” can be directly read from OUT_SIM(i) and from the state STAT_AV(i), respectively.

In a third step AS3, these KPI values KPI_VAL(i,j,k) and, In some embodiments, further aspects of the input IN_ANEN(i) to the analytics engine module MOD_ANEN, e.g. AV behavior AV_BEHA(i) and/or traffic behavior TRA_BEHA(i), are used to determine severity indicators SEV_EV(i,j) of the respective event types EV(i,j) of each simulation run SIM(i), for example based on analytical, AI, or other models. For example, such a model might determine the severity SEV_EV(i,j) of a collision event EV(i,j) by using relations known from literature between KPI values KPI_VAL(i,j,k) for energy transferred in the collision, type of traffic actors involved, relative velocity between the traffic actors, and position of impact and the severity of a collision. In a simple realization, a corresponding look-up table can be used to determine severity from KPI values. For the sake of clarity, the severity indicators SEV_EV are values, describing the severity of a respective event type, in principle like the KPI values KPI_VAL.

Thus, the third step AS3 provides severity indicators SEV_EV(i,j) for all identified events EV(i,j) of each simulation run SIM(i). Step AS3 might only executed in SF_IE, not in TR_IE.

Summarizing the first three steps AS1-AS3, the execution of those steps AS1-AS3 provides for each simulation run SIM(i) a set of event types EV(i,j) occured in a respective simulation run SIM(i) as well as KPI types KPI(I,j,k) which are characterizing for the occured event types EV(i,j) and the respective values KPI_VAL(i,j,k). Moreover, severity indicators SEV_EV(i,j) for the event types EV(i,j) are provided.

In a fourth step AS4, realizing a plurality of data aggregations, again performed by both SF_IE and TR_IE, selected KPI values KPI_VAL(i,j,k) from the second step AS2 and selected severity indicators SEV_EV(i,j) from the third step AS3 are processed. The respective selections are based on the input IN_ANEN(i) and IN_ADD (i) from OUT_SIM(i), respectively, as used in the individual simulation runs SIM(i). In other words, the selection to form a subset of the simulation runs SIM(i) for which respective KPI values are aggregated is based on a given condition which the selection runs to be selected to form the subset have to fulfill. Whether such condition is fulfilled by a particular simulation run SIM(i) can be determined from the input IN_ADD(i) used for the respective simulation run SIM(i).

In more general terms, the simulation runs SIM(i′) forming the subset of simulation runs can be selected from the entirety of simulation runs SIM(i) such that all the simulation runs SIM(I′) selected for the subset comprise a common value of at least one selection parameter of interest. Thus, for a certain subset, the value of such a selection parameter of interest is the same for all simulation runs of that subset. Therein, the selection parameter of interest might be one of the parameters of the input IN_ADD used as input for the simulation runs SIM(i). Also, it can be a certain location in the environment. For example, the parameter of interest taken from IN_ADD can be the “weather” assumed for a respective simulation run. With the value of the parameter “weather” possibly being “sunny” or “rainy” etc., all simulation runs assuming “rainy” weather would form a subset in this scenario. Simulation runs with “sunny” weather would form another subset.

In another example, the parameter of interest can be the “location” of an event EV. The value can be a certain coordinate in the simulated world, e.g. the location of a certain intersection. Therein, the requirement of a “common value” is not only fulfilled for exactly identical locations but it might suffice if the locations are similar to each other on a scale of meters, for example. However, in that scenario, it can be assumed that the subset of simulation runs will comprise all the simulation runs because that “common” location is actually available in all simulation runs. Thus, the subset can be identical to the entirety of simulation runs. This might also be applicable with other selection parameters. Coming back to the earlier example of “weather”, it is not excluded that all simulation runs are performed with the same value, e.g. “rainy”. In that case, all simulation runs have that value in common and the subset would, again, be identical to the entirety of simulation runs.

Coming back to the aggregation, the above means that for each KPI type individually, those respective KPI values are aggregated, e.g. summed up or averaged, possibly using weighing factors, which have been determined for those simulation runs SIM(i′) which are part of the subset SIM(i′) of simulation runs. Thus, for one subset of simulation runs, one aggregated KPI value results for each KPI type of each event type.

Similarly, for each severity indicator individually, those respective values are aggregated, e.g. summed up or averaged, possibly using weighing factors, which have been determined for those simulation runs SIM(i′) which are part of the subset SIM(i′) of simulation runs. Thus, for one subset of simulation runs, one aggregated severity indicator results for each event type.

The general event type EV=“accident” might be used as an example for the data aggregation approach in the fourth step AS4. A characterizing KPI type KPI=“total number of accidents” might be assigned to event type EV=“accident”. In this case, data aggregation might add the values KPI_VAL of KPI=“total number of accidents” during “sunny weather” and the values KPI_VAL of KPI=“total number of accidents” during “rainy weather”, wherein it is known from the input IN_ADD(i) whether a particular selection run SIM(i) fulfills one of the selection conditions “rainy weather” and “sunny weather”. Thus, a first subset of simulation runs SIM(i1) concerns simulations under “rainy weather” and a second subset of simulation runs SIM(i2) concerns simulations under “sunny weather”. In a first aggregation, the total number of accidents in simulation runs SIM(i1), i.e. with rainy weather, can be selected and added up, i.e. the respective KPI values KPI_VAL from simulation runs with rainy weather are simply added.

In a second aggregation, the total number of accidents in simulation runs SIM(i2), i.e. with sunny weather, can be added up, again by adding the respective KPI values. In another exemplary aggregation with the same selection criteria, i.e. “sunny” and “rainy” weather as described by IN_ADD (i) being part of IN_ANEN (i), an averaging of severity indicators SEV_EV of the event type “accident” can be performed. Therein, a first average of the severity indicators SEV_EV for the event type EV=“accident” for simulation runs SIM(i1) with rainy weather and a second average of the severity indicators SEV_EV for the event type EV=“accident” for simulation runs SIM(i2) with sunny weather are determined. For both aggregation types, i.e. “summing” and “averaging”, weighted sums and averages, respectively, might be calculated.

Just for example, in case ten simulation runs have SIM(i1) have been performed under the condition of “rainy weather”, but fifty simulation runs SIM(i2) have been performed under the condition of “sunny weather”, the KPI values KPI_VAL and severity indicators SEV_EV belonging to the “rainy weather” situation might be weighted five times stronger than the respective values belonging to “sunny weather” in the weighted summing and averaging, respectively.

The form of aggregation, e.g. “summing” or “averaging”, depends on the event type and KPI type, respectively, and on the conclusion which shall be derived from the aggregation. Such aggregations are performed for a particular event type EV(j) so that for each event type EV(j) one or typically several aggregation values are generated. In each aggregation, a subset of simulation runs SIM(i) is selected wherein the selection depends on the selected parameter from the input IN_ADD. In the example of the previous paragraph, the selection parameter is the “weather” situation, e.g. “rainy” for a first selection of simulation runs for aggregation of suitable KPI values and/or severity indicators and “sunny” for a second selection of simulation runs. In other words, simulation runs forming a particular subset for aggregation are selected based on a certain value of a certain input parameter IN_ADD(i), wherein such value might be, as above, “rainy weather” or “sunny weather” etc. Based on such given value (“sunny”, “rainy”) of the respective input parameter (“weather”) IN_ADD(i), those simulation runs from the entirety of simulation runs are selected to form a respective subset, which fulfill the selection condition.

In certain cases, a “subset” can also comprise the entirety of simulation runs.

Certain event types might be characterized by more than one KPI type. Correspondingly, aggregation of KPI values is performed for each characterizing KPI type of an event type, but not explicitly for each superordinated event type. Only in case an event type is characterized by only one KPI type, the KPI value aggregation can be assigned to the respective event type. However, since the severity indicators SEV_EV are determined for event types EV and not for subordinated individual KPI types, the aggregation of severity indicators SEV_EV is performed for each event type, but not for individual KPI_types.

In the above explanations a simple event type “accident” with simple KPI type “total number of accidents” was chosen for explanation. Also, the selection conditions “rainy weather” and “sunny weather” are simple to grasp. It should be clear that the simple example was chosen for the sake of clarity and that it must not be understood to be limiting the invention. Another KPI type assigned to the event type “accident” might be the “absolute distance travelled by the AV before an accident happens”. Of course, more differentiated event types and KPI types might be considered for aggregation and the selection of the respective subsets of simulation runs SIM(i) over which the aggregations would be applied might be based on other conditions than the “weather”. Thus, the method including steps AS1-AS4 typically results in a plurality of aggregated KPI values and severity indicators, each of different kind and content.

After the fourth step AS4, pluralities NKPI, NSEV of aggregated KPI values KPI_VAL_AGG(nk) with nk=1, . . . ,NKPI and aggregated severity indicators SEV_EV_AGG(ns) with ns=1, . . . ,NSEV are available which are used to form the risk insights RISK and traffic impact TRIM. As indicated earlier, RISK represents the safety of the AV, e.g. KPI types and event types in the field of accidents, near misses etc. Correspondingly, certain aggregated KPI values from KPI_VAL_AGG(nk) as well as certain aggregated severity indicators from SEV_EV_AGG(ns) in that AV safety related context are assigned to the risk insights RISK. As also indicated earlier, TRIM represents the traffic in the simulated world in more general terms, i.e. the performance of the traffic network, e.g. delays, reduction of the number of vehicles that can cross an intersection etc. Correspondingly, certain aggregated KPI values from KPI_VAL_AGG(nk) as well as certain aggregated severity indicators from SEV_EV_AGG(ns) in that traffic performance related context are assigned to the risk insights TRIM.

Thus, how to distinguish between relevance of such aggregated values for TRIM or for RISK might primarily depend on the KPI type: It depends on the KPI type whether an aggregated KPI value KPI_VAL_AGG is considered for TRIM or for RISK. E.g. KPI(J′,1) of event type EV(J′) and, therewith, the corresponding aggregation KPI_VAL_AGG(nk1) might be relevant for traffic performance and TRIM, respectively, while KPI(J′,2) of the same event type EV(J′) and, therewith, the corresponding aggregation KPI_VAL_AGG(nk2) might be relevant for the safety of the AV and RISK, respectively.

In case of the severity indicators SEV_EV, it might principally also depend on the KPI type whether a value SEV_EV is relevant for TRIM or for RISK. But actually, the severity indicators SEV_EV are determined only based on event types and they don't distinguish different KPI types. However, the KPI types are unambiguously connected to event types so that, consequently, one might say that in case of the severity indicators SEV_EV, it might depend on the event type EV whether a value SEV_EV and the related aggregation value SEV_EV_AGG is relevant for TRIM or for RISK.

Finally, both TRIM and RISK are sets of aggregation values of KPI values and severity indicators. A further aggregation applied by the method is location based in order to calculate an aggregated location risk score LOC_RSK_AGG. This is performed essentially via the same aggregation process as described before to calculate the value LOC_RSK_AGG, e.g. a weighted sum, wherein the aggregation is done based on the location LOC of the event types EV(j). Thus, the location LOC(1) based aggregation, with 1=1, . . . ,L counting different locations LOC(1) of interest in the simulated world, e.g. intersections or locations of higher traffic volume, includes aggregations of KPI values KPI_VAL and/or severity indicators SEN EV for certain selected event types EV. Therein, the location LOC can again be read from the input IN_ADD(i) and/or a location LOC(i) where an event of event type EV(j) happens is determined during simulation run SIM(i), preferably in the traffic simulator TR_SIM. In any case, information about the location LOC of the event of event type EV(j) in simulation run SIM(i) is part of the input data IN_ANEN(i) to the analytic engine module MOD_ANEN.

For example, again focusing on the event type EV=“accident”, the KPI values for KPI type “total number of accidents” during “sunny weather” as well as during “rainy weather” might be calculated as above for a particular central intersection LOC(1) in the simulated world.

The location based aggregation provides aggregated location risk scores LOC_RSK_AGG(l,j,k) for a location LOC(1) for event type EV(j) and KPI type KPI(j,k).

In the above explanations, the aggregation values KPI_VAL_AGG, SEV_EV_AGG, and LOC_RSK_AGG are calculated as absolute values. However, it might be more meaningful in some cases to provide relative values, e.g. the total number of accidents per driven distance or the number of accidents during rainy weather in relation to the number of accidents during sunny weather.

Summarizing the above w.r.t. the analytic engine module MOD_ANEN, the integral process foresees to extract KPI values KPI_VAL(i,j,k) and severity indicators SEV_EV(i,j) from individual simulation runs SIM(i) and to perform an aggregation, e.g. a weighted averaging or summing, to determine both absolute likelihood of well-defined safety incidents and traffic impact and relative likelihoods of these safety incidents and traffic impact as a function of simulation input parameters. Moreover, the location risk score is determined in this way.

The risk insights RISK and traffic impact TRIM determined therewith can be used in today's AV market the focus of which is on single vehicle AV development focused simulation, where effort is centered on the AV driving logic, the low-level sensor perception, and the routing and decision logic of the AV. In contrast, the simulation platform SIMPL introduced herein is focused on simulating the behavior of a single AV or a fleet of AVs in a given deployment environment. The platform SIMPL generates and uses localized traffic patterns and behaviors, analyzes the second order implications of the AV's driving behavior, and provides an understanding of the implications of AV deployment on the local traffic network, including insights into where AV deployment is potentially risky and under what conditions.

The output of the simulation platform SIMPL comprises traffic impact TRIM and risk insights RISK, both at least as absolute and preferably also relative values based on aggregated KPI values and severity indicators. Therein, the platform SIMPL makes use of a combination of a simulation engine for the autonomous vehicle AV to be deployed, realized by the AV simulation module AV_SIM, and traffic simulation in the deployment environment, realized by the traffic simulator TR_SIM, the integration with an AV stack AV_ST, and the integration with the analytic engine module MOD_ANEN to determine the impact of the AV on the deployment environment. In addition to the ability to run the analytics on real-world data as well.

Thus, the simulation platform SIMPL enables to create a digital twin of the deployment environment in which the AV deployment shall occur, including features such as the road surface, the road infrastructure, the traffic signal timing plans, the flows and movements of the traffic actors such as vehicles, cyclists, pedestrians, scooters, public transport etc. These inputs for the digital twin, mostly contained in the input IN_ADD, are acquired from various data sources, possibly by outside vendors.

Moreover, it is possible to create and parameterize seed scenarios specific to the deployment environment via tailored selection of the input IN_ADD(i) and pre-setting of the simulators TR_SIM, AV_SIM in order to look at the operation of a particular AV under varying conditions. The platform SIMPL allows to algorithmically generate a large set of simulation runs SIM(i) from those seed scenarios that look at AV safety, AV performance and deployment network impact under normal driving conditions, erratic conditions, and injection of specific events that are generic or specific to the deployment location in which the analysis is being performed.

Additionally, the platform SIMPL allows to scale the simulation data within MOD_SIM appropriately based on execution constraints (e.g. time, cost, etc.) by automatic selection of, for example, appropriate scenarios, parameters, number of actors, etc., and automatic translating conditions, for example boundary, initial, load, etc., between different system scales. Moreover, the platform SIMPL allows to co-simulate the behavior of the AV with other actors in the deployment environment including, but not limited to other AVs, motorists, mass transit, cyclists, and pedestrians.

As mentioned, the above assumed only one autonomous vehicle AV for the explanations in the context of the figures. However, the explanations can be expanded to a plurality of vehicles AV(a) and corresponding AV stacks AV_ST(a) with a=1, . . . ,A and A standing for the number of Avs to be deployed and simulated, respectively. For each AV(a), the simulation module MOD_SIM includes an AV simulator AV_SIM(a) and, as the case may be, an AV dynamics simulator AV_DYN_SIM(a), wherein each such simulator AV_SIM(a), AV_DYN_SIM(a) works as described above. However, only one traffic simulator TR_SIM is required. The output OUT_SIM(i) includes states STAT_AV(i,a) and dynamics AV_DYN(i,a) for each vehicle AV(a) as well as further data as introduced above. The KPI and severity calculations and aggregations can then be performed for each vehicle AV(a).

Summarizing the above in more general terms and on a high level, some of the embodiments of the teachings herein include a cloud-based platform SIMPL, comprising a simulation module MOD_SIM and an analytic engine module MOD_ANEN, that will enable automatic independent evaluation, represented by a respective “risk profile”, of any and every autonomous vehicle AV to be deployed in an environment. The evaluation might provide, for example, analysis and insights including the safety of the AV or of several AVs in the deployment environment, the impact of the one or more AVs on the deployment environment's traffic such as congestion, journey time, and flow, as well as the one or more risk profiles of the one or more AVs in the deployment environment, such as frequency of events and the severity of such events.

The platform SIMPL provides analysis and insights focused on AV deployment analysis, providing information to the AV ecosystem, such as Cities, Governments, Regulators, Fleet Operators, Insurances etc. The platform SIMPL enables the generation of safety and performance data to allow independent verification of AV actors in a specific deployment environment, using either a closed or open-source AV stack. Insights IMPA from the platform SIMPL based on TRIM and RISK might be used to either change the environment itself, e.g. by introducing or changing the traffic regulation, e.g. by tools like fixed and variable signs, and/or to adapt the AV stack AV_ST so that risks and general traffic impact caused by deploying the AV in the environment are reduced.

Moreover, it enables the generation of traffic scenarios unique to the deployment environment to capture both normal driving cases as well as those with erratic behaviors that may result in AV stack anomalies regarding either safety or performance. This includes prioritization and optimization to focus on the execution of relevant and meaningful scenarios, following a “quality over quantity” approach. Compared to today's real-world testing where a lot of miles are driven but nothing safety-related happens, resulting in potential safety-critical situations being missed due to their low probability of occurrence, the proposed system allows to specifically look for and execute these types of scenarios.

The platform SIMPL allows for analysis and presentation of resulting simulation data in a form unique to the domain of the specific user, while providing data transparency and allowing them to deep dive into the simulation results as needed.

In some embodiments, the proposed platform SIMPL is used each time there is a change to the deployment environment, including, for example, an update of AV software stack AV_ST, a change to the number of AVs deployed, and/or a change to the deployment environment, such as road works. The platform's analysis and insights are driven by the use of simulation and synthetic data, which will be supplemented over time by real-world data as and when such data becomes available.

While the teachings of the present disclosure have been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description. Thus, the teachings are not restricted to the above illustrated embodiments, but variations can be derived by a person skilled in the art without deviation from the scope of the present disclosure.

What is claimed is:

1. A method for estimating an impact resulting from deploying an autonomous vehicle (AV) characterized by an AV stack in an environment, the method comprising:
performing one or more simulation runs SIM(i) using a simulation module, with i=1, . . . ,I and I representing a total number of performed simulation runs SIM(i);
in each simulation run SIM(i), generating a simulated time dependent AV behavior AV_BEHA(i) in the environment and a simulated time dependent traffic behavior TRA_BEHA(i) of traffic in the environment, utilizing simulation conditions and data from the AV stack;
forming output data comprising the simulated AV behavior, the simulated traffic behavior, and at least a part of the input data; and
analyzing the output data for some or all of the simulation runs using an analytic engine module to estimate the impact based on the analysis result.

2. A method according to claim 1, wherein:
an AV simulator simulates the AV behavior;
a traffic simulator simulates the traffic behavior;
the AV behavior comprises time development of states of the vehicle AV; and
the traffic behavior comprises time development of states of variable traffic signs in the environment and time development of states of moving or movable traffic actors in the environment.

3. A method according to claim 2, wherein in each simulation run, the simulation of the AV behavior and of the traffic behavior is based on;
a mutual interaction of the AV simulator and the traffic simulator, wherein the AV simulator processes an output of the traffic simulator and the traffic simulator processes an output of the AV simulator;
a mutual interaction of the AV simulator with the AV stack, wherein the AV stack processes an AV worldview provided by the AV simulator and the AV simulator processes a vehicle control signal generated by the AV stack; and
processing of the input data in the AV simulator and in the traffic simulator.

4. A method according to claim 1, wherein
the simulation of the traffic behavior is based on the input data and on an output of the AV simulator; and
the simulation of the AV behavior is based on the input data, on an output of the traffic simulator, and on a vehicle AV control signal provided by the AV stack.

5. A method according to claim 1, wherein the AV stack is configured to process a worldview of the vehicle simulated in and received from the AV simulator to generate the data and to provide the data to the AV simulator.

6. A method according to claim 1, wherein:
the impact is composed of values of pre-defined key performance indicators and/or pre-defined severity indicators; and
the output data is analyzed for each simulation run to determine the values and/or the severity indicators.

7. A method according to claim 6, wherein:
the impact comprises safety related information and traffic performance,
the determined KPI values are assigned to the safety related information or to the traffic performance depending on a KPI type for which the respective KPI value has been determined, and/or
the determined severity indicators are assigned to the safety related information or to the traffic performance depending on an event type for which the respective severity indicator has been determined.

8. A method according to claim 6, wherein:
the values of the key performance indicators and/or the severity indicators, respectively, are determined based on preferably pre-defined event types EV(i,j) occurring in individual simulation runs SIM(i), with j=1, . . . ,J(i) and J(i) representing the number of different event types EV identified for a particular simulation run SIM(i); and
for each simulation run SIM(i); the event types EV(i,j) occurring in the respective simulation run are identified by analyzing the respective output.

9. A method according to claim 8, wherein, for the determination of the values of the key performance indicators, the for each identified event type EV(i,j) one or more key performance indicators KPI(i,j,k) characterizing the respective event type EV(i,j) as well as values KPI_VAL(i,j,k) of the determined characterizing key performance indicators KPI(i,j,k) are determined by analyzing the respective output, with k=1, . . . ,K(j) and K(j) representing the number of key performance indicators characterizing a particular event type EV(i,j).

10. A method according to claim 8, wherein for each identified event type the severity indicators are determined by processing the KPI values determined for the respective event type.

11. A method according to claim 6, wherein for each one of one or more of the KPI(i′,j,k) of a subset SIM(i′) of the simulation runs SIM(i) the respective KPI values KPI_VAL(i′,j,k) are aggregated to form for each such key performance indicator KPI(i′,j,k) an aggregated KPI value KPI_VAL_{subi′}, (j, k), wherein such an aggregated KPI value KPI_VAL_{subi′}(j, k) represents one of the KPI values for composing the impact.

12. A method according to claim 6, wherein for each one of one or more of the severity indicators SEV_EV(i′,j) of a subset SIM(i′) of the simulation runs SIM(i) the respective severity indicators SEV_EV(i′,j) are aggregated to form an aggregated severity indicator SEV_EV_{subi′}(j), wherein such aggregated severity indicator SEV_EV_{subi′}(j) represents one of the severity indicators for composing the impact.

13. A method according to claim 11, wherein the simulation runs SIM(I′) forming the subset of simulation runs are selected from the entirety of simulation runs SIM(i) such that the selected simulation runs SIM(I′) have in common a value of at least one selection parameter of interest.

14. A method according to claim 13, wherein the selection parameter of interest comprises:
a parameter of the input used as input for the simulation runs or
a location in the environment.

15. (canceled)
